(19) United States
(12) Patent Application Publication
(10) Pub. No.: US 2013/0272474 A1
(43) Pub. Date: Oct. 17, 2013

(54) PASSIVE CONTAINMENT AIR COOLING FOR NUCLEAR POWER PLANTS

(71) Applicants: Lawrence E. Conway, Monroeville, PA (US); Richard P. Ofstun, Plum Borough, PA (US); Alex W. Harkness, Gibsonia, PA (US); Terry L. Schulz, Murrysville, PA (US)

(72) Inventors: Lawrence E. Conway, Monroeville, PA (US); Richard P. Ofstun, Plum Borough, PA (US); Alex W. Harkness, Gibsonia, PA (US); Terry L. Schulz, Murrysville, PA (US)

(73) Assignee: WESTINGHOUSE ELECTRIC COMPANY LLC, Cranberry Township, PA (US)

(21) Appl. No.: 13/444,932

(22) Filed: Apr. 12, 2012

(51) Int. Cl. G21C 9/00

(52) U.S. Cl. 376/299

(57) ABSTRACT

An enhanced passive containment air cooling system for a nuclear power plant that increases the heat transfer surface on the exterior of the nuclear plant's containment vessel. The increased surface area is created by forming a tortuous path in or on at least a substantial part of the exterior surface of the containment vessel over which a cooling fluid can flow and follow the tortuous path. The tortuous path is formed from a series of indentations and protrusions in or on the exterior surface that form a circuitous path for the cooling fluid.

### CROSS REFERENCE TO RELATED APPLICATIONS

This application is related to co-pending patent application Ser. No. ______, (Attorney Docket NPP 2011-006), filed concurrently herewith.

### BACKGROUND

1. Field

The present invention relates to a passive containment cooling system for a nuclear reactor power plant and more specifically to a passive containment air cooling system that relies on the natural flow of air over the surface of a metal containment.

2. Related Art

Nuclear power has played an important part in the generation of electricity since the 1950's and has advantages over thermal electric and hydroelectric power plants due to its efficiency, safety and environmental preservation. The generation of electricity by nuclear power is accomplished by the nuclear fission of radioactive materials. Due to the volatility of the nuclear reaction, nuclear power plants are required by practice to be designed in such a manner that the health and safety of the public is assured even for the most adverse accident that can be postulated. For plants utilizing light water as a coolant, the most adverse accident is considered to be a double-ended break of the largest pipe in the reactor cooling system and is termed a Loss of Coolant Accident (LOCA).

For accident protection, these plants utilize containment systems that are designed to physically contain water, steam and any entrained fission products that may escape from the reactor cooling system. The containment system is normally considered to encompass all structures, systems and devices that provide ultimate reliability and complete protection for any accident that may occur. Engineered safeguard systems are specifically designed to mitigate the consequences of an accident. Basically, the design goal of a containment system is that no radioactive material escapes from the nuclear power plant in the event of an accident so that the lives of the surrounding populous are not endangered.

Recently, reactor manufacturers have offered passive plant designs, i.e. plants that will shut down in the event of an accident without operator intervention or off-site power. Westinghouse Electric Company LLC offers the AP1000 passive plant design that employs a passive containment cooling system that uses a large steel shell. The containment cooling system suppresses the rise in pressure that will likely occur within the containment in the unlikely event of a loss of coolant accident. The passive containment cooling system is an engineered safety feature system. Its objective is to reduce the containment temperature and pressure following a loss of coolant accident or steam line break accident inside the containment by removing thermal energy from the containment atmosphere. The passive containment cooling system also serves as a means of transferring heat for other events resulting in a significant increase in containment pressure and temperature. The passive containment cooling system also limits releases of radioactivity (post accident) by reducing the pressure differential between the containment atmosphere and the external environment, thereby diminishing the driving force for leakage of fission products from the containment to the atmosphere. To achieve the foregoing objectives, the containment building is made of steel to provide efficient heat transfer from within to outside of the containment. During normal operation, heat is removed from the containment vessel by continuous natural circulation of air. During an accident, however, more heat removal is required and air cooling is supplemented by evaporation of water, provided by a passive containment cooling system water storage tank.

An AP1000 containment system 10 is schematically illustrated in FIG. 1 surrounding an AP1000 reactor system including a reactor vessel 12, steam generator 14, pressurizer 16 and main coolant circulation pump 18; all connected by the piping 20. The containment system 10 in part comprises a steel dome containment vessel enclosure 22 surrounded by a concrete shield building 24 which provides structural protection for the steel dome containment vessel 22.

The major components of the passive containment cooling system are a passive containment cooling water storage tank 26, an air baffle 28, air inlet 30, air exhaust 32 and water distribution system 34. The passive containment cooling water storage tank 26 is incorporated into the shield building structure 24, above the steel dome containment vessel 22. An air baffle 28 located between the steel dome containment vessel 22 and the concrete shield building 24 defines the cooling air flow path which enters through an opening in the shield building 24 at an elevation approximately at the top of the steel dome containment vessel 22. After entering the shield building 24, the air path travels down one side of the air baffle 28 and reverses direction around the air baffle at an elevation adjacent the lower portion of the steel dome containment vessel and then flows up between the baffle and the steel dome containment vessel 22 and exits at the exhaust opening 32 in the top of the shield building 24. The exhaust opening 32 is surrounded by the passive containment cooling water storage tank 26.

In the unlikely event of an accident, the passive containment cooling system provides water that drains by gravity from the passive containment cooling water storage tank and forms a film over the steel dome containment vessel 22. The water film evaporates thus removing heat from the steel dome containment building 22.

The passive containment cooling system is capable of removing sufficient thermal energy, including subsequent decay heat, from the containment atmosphere following a Design Basis event resulting in containment pressurization such that the containment pressure remains below the design value with no operator action required for at least 72 hours.

The air flow path that is formed between the shield building 24, which surrounds the steel dome containment vessel 22, and the air baffle 28 results in the natural circulation of air upward along the containment vessel's outside steel surface. This natural circulation of air is driven by buoyant forces when the flowing air is heated by the containment steel surface and when the air is heated by and evaporates water that is applied to the containment surface. The flowing air also enhances the evaporation that occurs from the water surface. In the event of an accident, the convective heat transfer to the air by the heated containment steel surface only accounts for a small portion of the total heat transfer that is required, such total heat transfer being primarily accomplished by the evaporation of water from the wetted areas of the containment steel surface, which cools the water on the surface, which then cools the containment steel, which then cools the inside containment atmosphere and condenses steam within the containment.

In order to maintain a sufficient transfer of heat from the steel dome containment vessel 22, to limit and reduce containment pressure, after the initial three days following a postulated Design Basis event, the AP1000 passive containment cooling system requires that the water continues to be applied to the containment outside steel surface. The water is provided initially by the passive gravity flow mentioned above. After three days, water is provided by active means initially from onsite water storage and then from other onsite or offsite sources.

It is an object of this invention to enable air cooling alone to provide sufficient heat removal to maintain acceptably low containment pressure after the initial three days.

Furthermore, it is an object of this invention to enable air cooling to provide such sufficient heat removal with no reliance on active components, operator actions, or nonsafety onsite or offsite water supplies.

Additionally, it is an object of this invention to provide sufficient air cooling that will enable a reduction in the size of the passive containment cooling water storage tank that is required.

### SUMMARY

These and other objects are achieved in accordance with this invention by a solid metal shell having an enhanced exterior surface area, that is sized to surround at least the primary system of a nuclear reactor plant. The solid metal shell has an interior and exterior surface, with a tortuous path formed in or on at least a substantial part of the exterior surface over which a cooling fluid can flow and substantially follow the tortuous path. Preferably, the interior surface of the solid metal shell is smooth and the tortuous path is formed from a series of indentations and protrusions in or on the exterior surface that create a circuitous path for the cooling fluid. The indentations and protrusions may be formed in modules with each module having a pattern of a plurality of the indentations and protrusions arranged in a pattern and each module is attached to the exterior surface of the solid metal shell through a heat conducting path. Each of the modules may be laterally offset in the vertical direction from an adjacent module to extend the tortuous path.

In one embodiment, the tortuous path is formed in or on and in heat exchange relationship to the exterior surface by a pattern of a plurality of fins, wherein the protrusions are the fins and the indentations are the areas between the fins. In still another embodiment, the tortuous path is formed in or on and in heat exchange relationship to the exterior surface by a pattern of a plurality of horizontal trips, wherein the protrusions are the trips and the indentations are the areas between trips. In still another embodiment, the protrusions and indentations are formed from a texture on the exterior surface of the solid metal shell and in one form the texture is in the shape of a waffle pattern.

### BRIEF DESCRIPTION OF THE DRAWINGS

A further understanding of the embodiments described herein can be gained from the following description when read in conjunction with the accompanying drawings in which:

FIG. 1 is a simplified schematic of an AP1000 nuclear power plant;

FIG. 2 is a plan view of a cross section of a circumferential section of a steel plate of the containment vessel incorporating one embodiment described hereafter;

FIG. 3 is a cross section of a circumferential section of a steel plate of the containment vessel incorporating a second embodiment;

FIG. 4 is a perspective view of a module of still another embodiment attached to a circumferential section of the steel plate of the containment vessel;

FIG. 5 is a perspective view of the surface texture of a section of a steel containment vessel employing another embodiment;

FIG. 6 is a perspective view of a section of the steel plate of the containment vessel incorporating still another embodiment; and

FIG. 7 is a perspective view of a section of steel plate that employs raised trips in accordance with another embodiment.

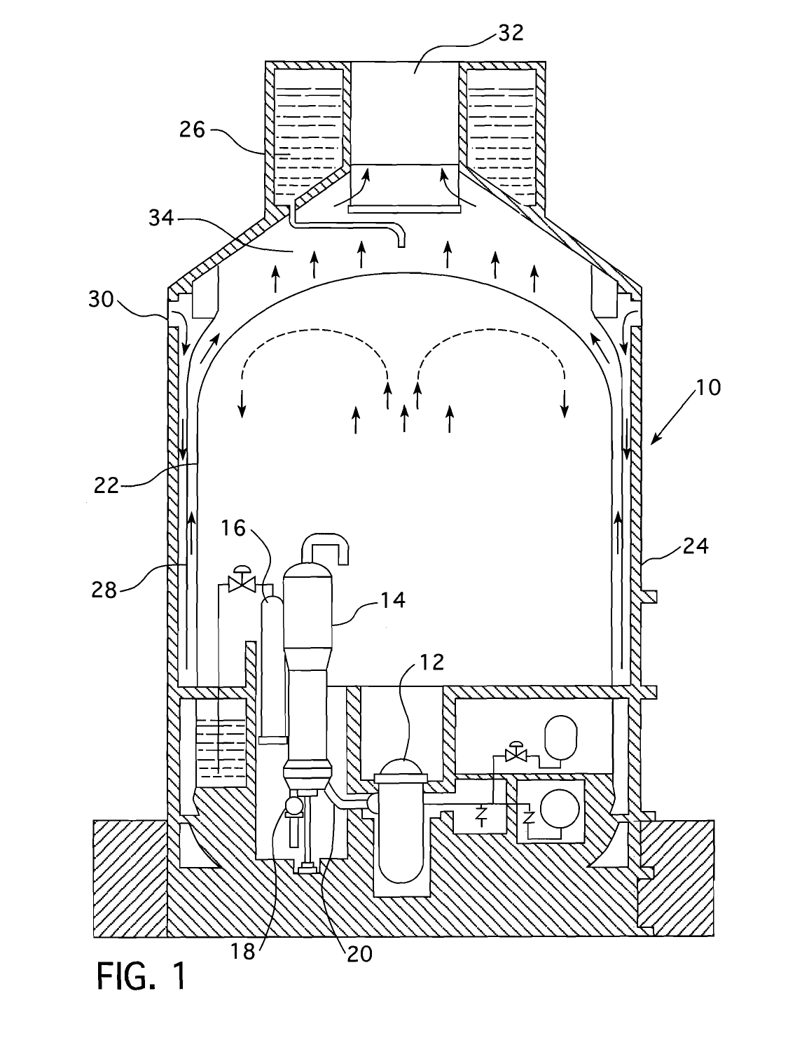

### DESCRIPTION OF THE PREFERRED EMBODIMENT

As previously mentioned, in an AP1000 passive cooling containment system, the convective heat transfer to the air by the heated containment steel surface only accounts for a small portion of the total heat transfer; such total heat transfer being primarily accomplished by the evaporation of water from the wetted areas of the containment steel surface, which cools the water on the surface, which then cools the containment steel, which then cools the inside containment atmosphere and condenses steam. This invention enables air cooling alone to provide sufficient heat removal to maintain acceptably low containment pressure with no reliance on active components, operator actions, or auxiliary water supplies, after the initial three days when the initial water volume in the passive containment cooling water storage tank 26 has been exhausted.

The foregoing object is achieved by creating a tortuous air path in or on at least a substantial part of the exterior surface of the steel containment vessel 22 over which the cooling air flows. Though, the containment vessel is identified as being constructed out of steel it should be appreciated that the containment vessel can be constructed out of other materials that have relative good thermal conductivity and the necessary integrity and strength. Also, it should be appreciated that the water film during the discharge of the passive containment cooling water storage tank 26, will follow some of the same path as the air path but in a concurrent direction.

Preferably, the tortuous path is defined by a series of indentations and protrusions in or on the exterior surface of the containment vessel 22 that form a circuitous path for the flow of the cooling fluid. Furthermore, it should be noted that the circuitous path may cover substantially the entire exterior surface of the containment vessel or only critical portions thereof.

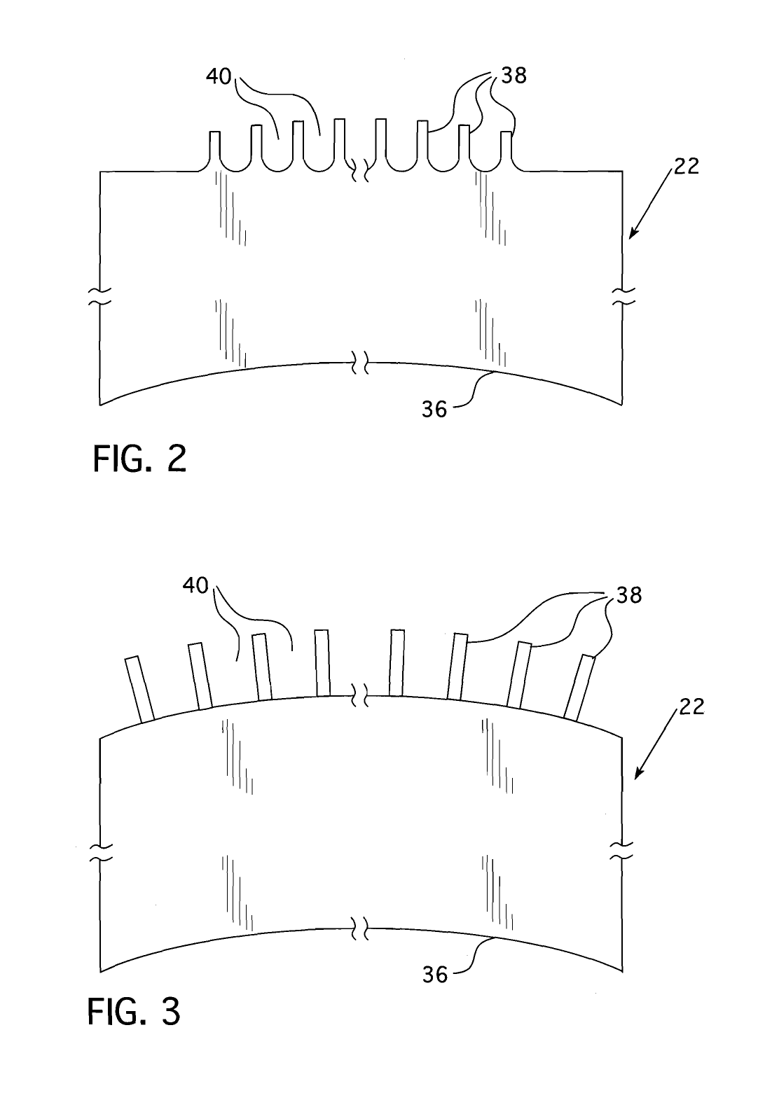

FIG. 2 shows a circumferential section of the steel plate of the containment vessel with a smooth wall 36 shown on the interior side and vertical fins 38 shown on the exterior side. It should be appreciated that the fins may continuously extend over the exterior of the containment or may just cover critical sections. In one embodiment, the steel plate 22 can be manufactured by removing material between the fins 38 by machining the steel plate to form indentations 40. A typical steel plate that will form a portion of a containment vessel built up in sections, with each section welded to an adjacent section, would have a depth of approximately 1.75 inch (4.45 centimeters) and a length of approximately 30 feet (7.62 meters). Desirably, the spacing between fins is approximately 5/16 inch (0.79 centimeters). The indentations 40 would extend approximately ⅜ inch (0.85 centimeters) into the material.

The embodiment shown in FIG. 3 is an alternate to the embodiment illustrated in FIG. 2 that uses fins 38 formed from separate sheets of steel that are respectively welded to the steel plate that forms a section of the containment vessel 22. The fin height, thickness and spacing are selected to achieve the desired heat transfer with the dimensions noted for FIG. 2 designed to accommodate the AP1000 plant design.

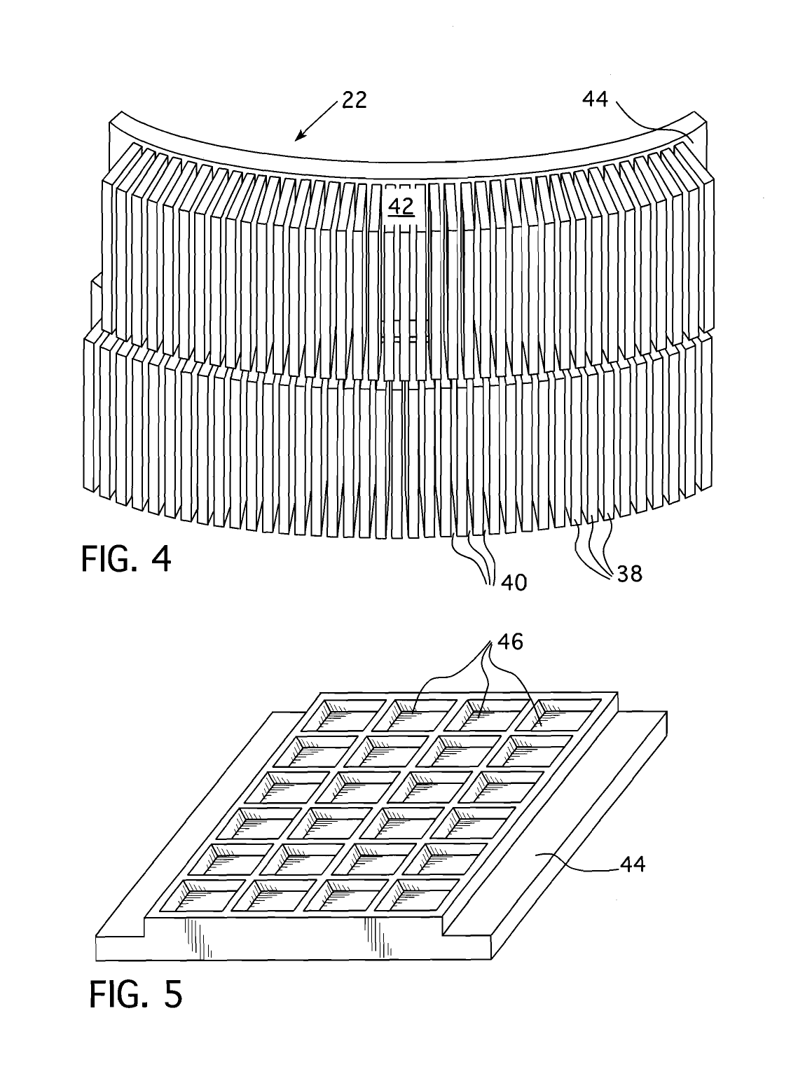

FIG. 4 shows still another alternate embodiment to those of FIGS. 2 and 3, in which the fins 38 and the indentations 40 are manufactured in modules 42 that are bonded to the steel plate 44 after the plate 44 is rolled or pressed into shape to form a segment of the containment vessel 22. It should be appreciated that adjacent modules 42 can be arranged in line or can be offset as shown in FIG. 4 to increase the tortuous air path.

Another alternate embodiment is illustrated in FIG. 5. In FIG. 5, the exterior surface of a steel plate 44 is formed with a texture, such as the waffle design 46 shown in FIG. 5. The “waffle” surface or “dimpled” surface enhances the wetted surface area and can manage water usage if most effectively applied to the domed region of the containment vessel 22 where the indentations, or pockets, will fill with water such that the water flow can be controlled so as to not drain from the containment dome onto the containment sidewall so that the sidewall will be air cooled while the dome area of the containment is cooled by evaporating water into the air heated by the sidewall dry surface. The water can be controlled through the size of the orifice at the outlet of the tank 26 or through the use of a thermally operated or pressure sensitive valve.

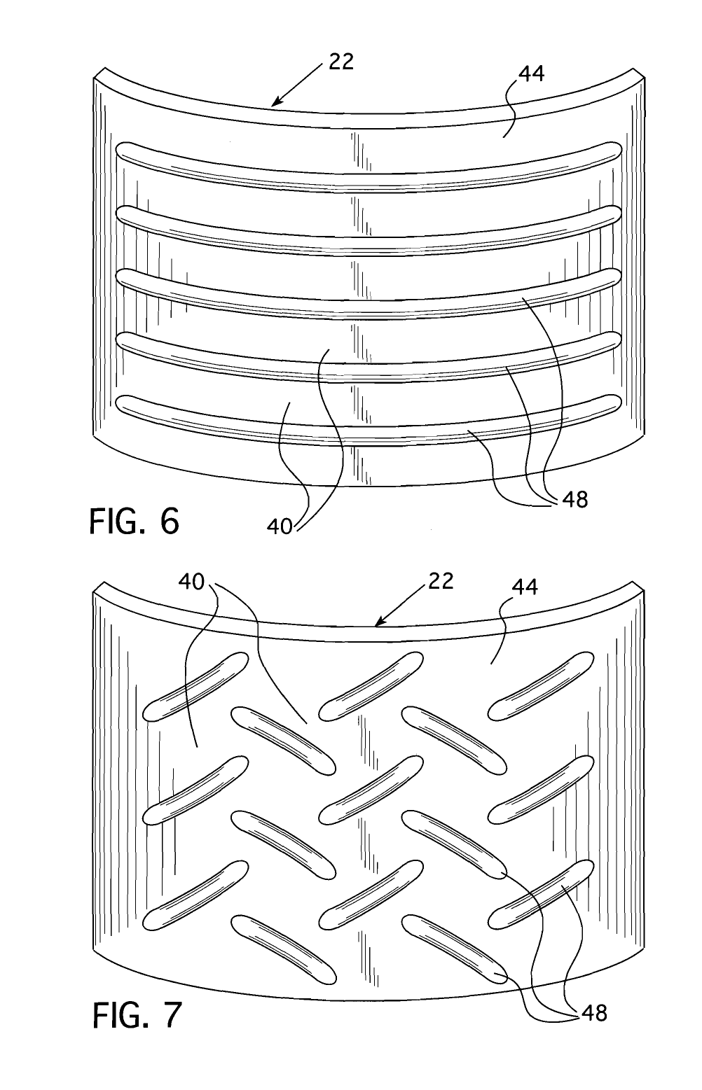

FIG. 6 shows still another embodiment that employs trips 48 in lieu of fins. The trips 48 are distinguished from the fins 38 in that the fins extend generally in the direction of cooling fluid flow while the “trips” extend generally in a direction to disturb coolant flow and enhance convective heat transfer. The “trips,” like the “fins,” are spaced periodically to form an alternate series of protrusions 48 and indentations 40.

FIG. 7 shows another embodiment in which the “trips” are arranged diagonally in alternate directions to both disturb air flow as well as extend the air flow path.

It should be further appreciated that several of these designs for disturbing the coolant flow path and/or increasing the length or surface area of the coolant flow path may be used over different regions of the containment vessel at the same time. For example, the fins or trips could be used on the sides of the containment vessel while the waffle pattern could be used over the domed region. Furthermore, while an increase in the air flow path can be achieved by designing the air baffle 28 with guides to create the circuitous air path, it would not be as efficient as the increased heat transfer surface area provided by the foregoing embodiments.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A nuclear reactor containment comprising:
a solid metal shell sized to surround at least a top and sides of a primary coolant loop of a nuclear reactor system, the solid metal shell having an interior and exterior surface; and
a tortuous path formed in or on at least a substantial part of said exterior surface over which a cooling fluid can flow and substantially follow the tortuous path.

2. The nuclear reactor containment of claim 1 wherein the interior surface is substantially smooth.

3. The nuclear reactor containment of claim 1 wherein the tortuous path is formed from a series of indentations and protrusions in or on the exterior surface that form a circuitous path for the cooling fluid.

4. The nuclear reactor containment of claim 3 wherein the tortuous path is formed in or on and in heat exchange relationship to the exterior surface by a pattern of a plurality of fins, wherein the protrusions are the fins and the indentations are the areas between the fins.

5. The nuclear reactor containment of claim 4 wherein the fins are formed in modules each comprising a plurality of the fins arranged in the pattern and each module is attached to the exterior surface through a heat conducting path.

6. The nuclear containment of claim 3 wherein the indentations and protrusions are formed in modules with each module having a pattern of a plurality of the indentations and protrusions arranged in a pattern and each module is attached to the exterior surface through a heat conducting path.

7. The nuclear containment of claim 6 wherein each module is laterally offset from an adjacent module in the vertical direction.

8. The nuclear reactor containment of claim 3 wherein the tortuous path is formed in or on and in heat exchange relationship to the exterior surface by a pattern of a plurality of trips, wherein the protrusions are the trips and the indentations are the areas between the trips.

9. The nuclear reactor containment of claim 3 wherein the protrusions and indentations are formed from a texture on the exterior surface.

10. The nuclear reactor containment of claim 9 wherein the texture is formed in the shape of a waffle pattern.

11. The nuclear reactor containment of claim 9 wherein the solid metal shell includes a top portion and a sidewall portion and the protrusions and indentations in at least a part of the top portion form pockets in which the cooling fluid can collect, including means for passively controlling the amount of cooling fluid that flows onto the top portion so that most of the cooling fluid evaporates before it flows over the top portion onto the sidewall portion.
